(19) United States
(12) Patent Application Publication
(10) Pub. No.: US 2026/0332265 A1
(43) Pub. Date: Oct. 22, 2026

(54) Optical Signal Processing Device and Method for Controlling the Same

(71) Applicant: NTT, Inc., Tokyo (JP)

(72) Inventors: Yoshie Morimoto, Musashino-shi, Tokyo (JP); Kenya Suzuki, Musashino-shi, Tokyo (JP); Keita Yamaguchi, Musashino-shi, Tokyo (JP)

(21) Appl. No.: 19/115,676

(22) PCT Filed: Oct. 28, 2022
(86) PCT No.: PCT/JP2022/040525

§ 371 Date: Mar. 26, 2025

(51) Int. Cl. H04B 10/294; G02F 1/225; H04J 14/02

(52) U.S. Cl. CPC H04B 10/294; G02F 1/225; H04J 14/02

(57) ABSTRACT

The present invention solves a problem that a wavelength spectrum is changed in an analogue manner in the middle of setting change in a plurality of phase shifters, so that the wavelength spectrum is largely deviated from a desired wavelength spectrum. The optical signal processing device of the present invention divides a period between a current phase modulation amount and a target phase modulation amount into M, acquires M+1 phase modulation amounts including the current phase modulation amount and the target modulation amount, and gradually changes setting of the phase modulation amount to be added by each phase shifter.

### TECHNICAL FIELD

The present invention relates to an optical signal processing device, and more particularly to a technique for controlling a phase modulation amount of an optical signal propagating through an optical waveguide.

### BACKGROUND ART

Wavelength division multiplexing (WDM) technology used in optical communication networks is considered important as means to increase the capacity of optical communication.

Particularly, in order to apply the WDM technique to long-distance transmission over 100 km or more, it is necessary to dispose optical amplifiers at constant intervals in a transmission fiber, and the wavelength dependency of a gain spectrum greatly influences an optical signal-to-noise ratio (OSNR). Therefore, it is necessary to flatten the gain spectrum. As the gain equalizer, a gain equalizer configured with a quartz glass waveguide disclosed in NPL 1 has been proposed. In addition, NPL 2 discloses a gain equalizer having a configuration called a lattice type optical circuit.

A lattice type optical circuit is formed by N−1 arm waveguides composed of N directional couplers and two waveguides interposed therebetween. In addition, by applying heat to any one of the waveguides of two waveguides forming an arm waveguide, the phase of light propagating through the waveguide is controlled by operating a phase shifter that utilizes a change in refractive index caused by the thermo-optic effect. This control makes it possible to adjust the phase difference between the optical signals propagating through the two waveguides forming the arm waveguide, and it is also possible to adjust the interference state in the subsequent directional coupler, thereby controlling the transmission spectrum with respect to the wavelength.

As described above, an optical signal processing device including an optical waveguide and a plurality of phase shifters for phase-shifting an optical signal propagating through the optical waveguide is widely used in an optical communication network. One example of this is a lattice type optical circuit including N directional couplers, N−1 arm waveguides consisting of two waveguides sandwiched therebetween, and a maximum of 2(N−1) phase shifters loaded on at least one of the two waveguides forming the arm waveguide. The phase difference Θi occurring between the upper arm waveguide and the lower arm waveguide in the i-th arm waveguide of the lattice optical circuit is expressed by Equation (1).

$$[ Math . 1 ]$$

$${Θ}_{i} = \frac{2 π}{λ} {n}_{eff} Δ {L}_{i} + {ϕ}_{i} \qquad ( 1 )$$

Here, λ is the wavelength of light, n_{eff} is the effective refractive index of the optical waveguide, ΔLi is the difference in length between the upper arm waveguide and the lower arm waveguide in the i-th arm waveguide, and φi is the phase difference applied between the arms by controlling the phase shifter in the i-th arm waveguide. By individually controlling phase modulation amounts applied by the plurality of phase shifters, a phase difference Ti in each arm waveguide is controlled, and a finally output wavelength spectrum is controlled. Since the phase shifter settings can be freely changed while passing through the optical signal, the wavelength spectrum can be changed sequentially and arbitrarily according to the optical signal transmission state.

### CITATION LIST

### Non Patent Literature

[NPL 1] K. Suzuki, T. Kitoh, S. Suzuki, Y. Inoue, Y. Hbbino, T. Shibata, A. Mori, and M. Shimizu, “Ultra wide range dynamic gain equalizer with high contrast silica planar lightwave circuit,” in Integrated Photonics Research, A. Sawchuk, ed., Vol. 78 of OSA Trends in Optics and Photonics (Optical Society of America, 2002), paper IThG2.
[NPL 2] T. R. Schlipf, M. W. Street, J. Pandavenes, R. McBride, and D. R. S. Cumming, “Design and Analysis of a Control System for an Optical Delay-Line Circuit Used as Reconfigurable Gain Equalizer,” Journal of Lightwave Technology, 2003, Vol. 21, Issue 9, pp. 1944.

### SUMMARY OF INVENTION

### Technical Problem

However, when the wavelength spectrum of the optical signal processing device is changed, the waveform continues to change continuously in the middle of setting a plurality of phase shifters, and therefore, in a case where the phase modulation amount to be set is large, the waveform may deviate greatly from the desired wavelength spectrum to be changed. In a case where the optical characteristics have greatly deviated from the desired wavelength spectrum, there is a possibility that the optical signal to be transmitted will be interrupted.

An object of the present invention is to provide an optical signal processing device capable of obtaining a desired wavelength spectrum even if settings of a phase modulation amount of a phase shifter are changed during optical signal transmission.

### Solution to Problem

A method for controlling an optical signal processing device including an optical waveguide formed on a substrate; and N phase shifters that apply a phase shift to an optical signal propagating in the optical waveguide of the present invention includes a first step of dividing a period between a phase shift amount currently added and a target phase shift amount by a division number M, and acquiring (M+1) phase shift amounts including phase shift amounts before and after the change for each of the N phase shifters, a second step of changing a phase shift amount to be applied to each of the N phase shifters from a k-th phase shift amount to a (k+1)-th phase shift amount among the (M+1) phase shift amounts, from a first phase shifter to an N-th phase shifter among the phase shifters, and processing of repeating the second step M times from k=1 to k=M.

### Advantageous Effects of Invention

According to the above-described configuration, it is possible to obtain a desired wavelength spectrum even if the setting of the phase modulation amount of the phase shifter is changed during the transmission of the optical signal in the optical signal processing device.

### BRIEF DESCRIPTION OF DRAWINGS

FIG. 1 is a top view of an optical signal processing device of the present invention.

FIG. 2 is a graph illustrating a wavelength spectrum of a transmittance of a lattice type optical circuit.

FIG. 3 is a flowchart illustrating processing of linearly dividing a period between a current phase modulation amount and a target phase modulation amount to determine a division number M according to a first embodiment of the present invention.

FIG. 4 is a diagram illustrating a lookup table according to a modification example of the first embodiment of the present invention.

FIG. 5 is a diagram illustrating a phase modulation amount in a phase shifter at each step according to the first embodiment.

FIG. 6 is a flowchart illustrating processing of determining the division number M in a case where the lookup table shown in FIG. 4 is used.

FIG. 7(a) is a diagram illustrating an example of a phase modulation amount being applied by each phase shifter for each spectral slope according to a second embodiment of the present invention, and FIG. 7(b) is a diagram illustrating an example of a graph after dividing the phase modulation amount.

FIG. 8 is a diagram illustrating a lookup table for defining the phase modulation amount for each spectral slope according to the second embodiment.

### DESCRIPTION OF EMBODIMENTS

### (Structure of Optical Signal Processing Device)

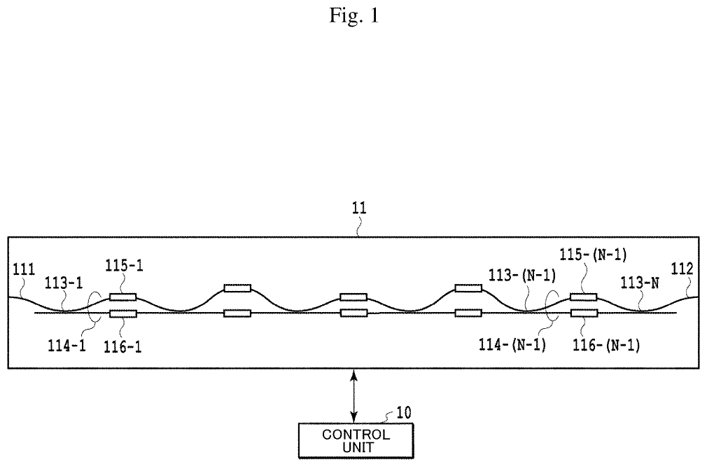

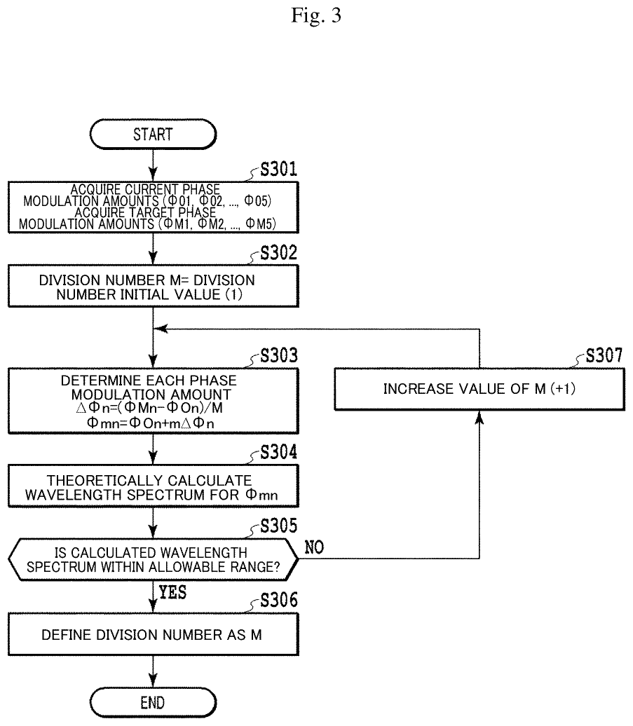

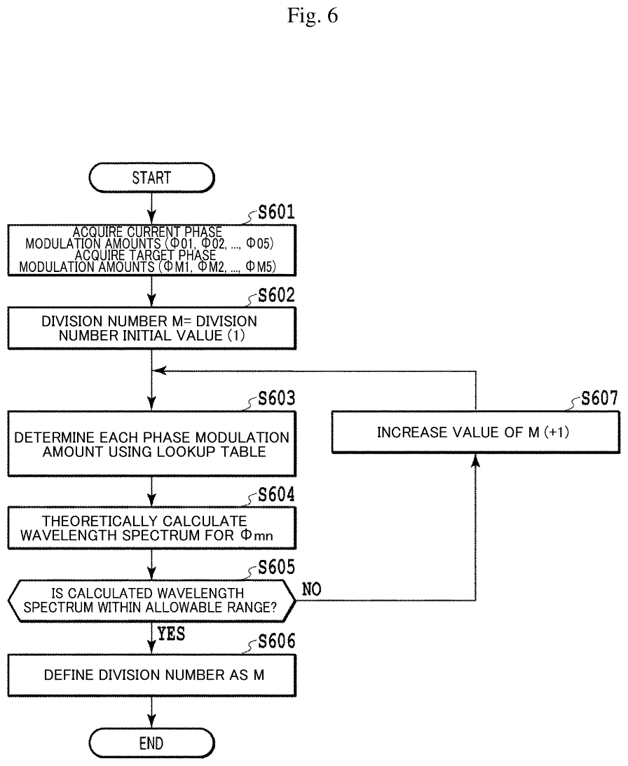

FIG. 1 is a diagram schematically illustrating an optical signal processing device according to an embodiment of the present invention. Although the optical signal processing device of the present embodiment shows the case of a lattice type optical circuit as an example of the form of the optical waveguide, the form of the optical waveguide is not limited thereto. The optical signal processing device of the present embodiment comprises a lattice type optical circuit 11 and a control unit 10 that controls the phase modulation amount by a phase shifter having a phase modulation function in the optical circuit. The control unit may also execute a phase modulation amount division process described later with reference to FIGS. 3 and 6.

The control unit 10 has a CPU, a memory storing programs for controlling an optical signal processing device to be described later, dividing a phase modulation amount, and the like, which are executed by the CPU, and executes the control processing of the phase modulation amount by the phase shifter described below. The lattice type optical circuit 11 includes an input waveguide 111, a plurality of optical directional couplers 113-1 to 113-N, arm waveguides 114-1 to 114-(N−1), and an output waveguide 112. The arm waveguides 114-1 to 114-(N−1) are composed of two waveguides, and phase shifters 115-1 to 115-(N−1), and 116-1 to 116-(N−1) are loaded in both waveguides respectively. It is apparent from the following description that, in order to execute the phase modulation processing of the present invention, it is sufficient that a phase shifter is loaded in at least one of the two waveguides.

The signal light input from the input waveguide 111 passes alternately through the optical directional couplers 113-1 to 113-N and the arm waveguides 114-1 to 114-(N−1), and then passes through the output waveguide 112 and is output from the output waveguide 112.

### (Phase Shifter)

The phase shifters 115-1 to 115-(N−1) and 116-1 to 116-(N−1) arranged in the arm waveguides 114-1 to 114-(N−1) respectively control the phases of optical signals passing through the corresponding waveguides. Although the principle of the phase shifter does not matter insofar as long as it can control the phase of the optical signal passing therethrough, examples of the phase shifter include a thermo-optic phase shifter that utilizes heat generated by a heater and the thermo-optic effect. In the case of a thermo-optic phase shifter, heat to be generated is controlled by the current amount applied to a heater, and the amount of phase modulation is controlled by the accompanying change in the refractive index of the waveguide.

### (Control of Optical Signal Processing Device)

In the following, the control of the optical signal processing device according to an embodiment of the present invention will be described, but in order to simplify the illustration and description, a case where the lattice type optical circuit is constituted by six directional couplers and five arm waveguide pairs (N=6) will be described. In addition, for the purpose of simplifying the illustration and description, the phase shifters 115-1 to 115-5 are arranged only in one waveguide of two arm waveguides 114-1 to 114-5 in the phase shifter.

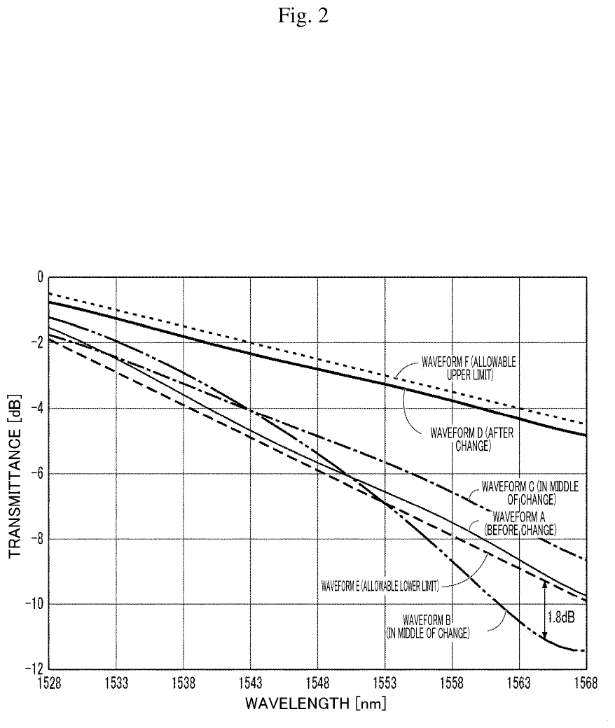

FIG. 2 is a graph illustrating the wavelength spectrum of the transmittance of the optical signal in the lattice type optical circuit 11, in which the vertical axis shows the transmittance and the horizontal axis shows the wavelength of the light. In FIG. 2, a waveform A is a waveform currently set as a transmission spectrum in the lattice type optical circuit 11, and as an example, is a waveform showing a nearly linear spectrum with a slope of about −0.2 dB/nm. In addition, a waveform D is a target transmittance spectrum waveform for phase amount variable control, and as an example, a substantially linear spectrum waveform with a slope of about −0.1 dB/nm. Then, the current phase modulation amounts added by the phase shifters 115-1 to 115-5 are respectively set to φ01, φ02, φ03, φ04, and φ05. In response to the above setting, the transmission spectrum of the lattice type optical circuit 11 is changed from the current set waveform A to the target set waveform D by changing the phase modulation amount given by each phase shifter. Here, the target phase modulation amounts to be added by phase shifters 115-1 to 115-5 to obtain the target set waveform D are set to φM1, φM2, φM3, φM4, and φM5.

The transmission spectrum in the course of the waveform change may be within a range allowed in the optical communication network, and in the example shown in FIG. 2, the transmission spectrum is a range sandwiched between a waveform F (allowable upper limit) and a waveform E (allowable lower limit). This is in the range of ±0.3 dB for waveform A and waveform D, respectively.

When the waveform is changed, if the phase modulation amount added by phase shifters 115-1 to 115-5 is directly changed from the current phase modulation amounts φ01, φ02, φ03, φ04, and φ05 to the target phase modulation amounts φM1, φM2, φM3, φM4, and φM5, the waveform continues to change continuously during the change by the five phase shifters as described above, and therefore, the transmission spectrum of the lattice type optical circuit may exceed an allowable range at a certain timing during the change of the setting. For example, the waveform B illustrated in FIG. 2 is an example of a transmission spectrum in the middle of changing the setting of the phase modulation amount to be added by the phase shifters 115-1 to 115-5, and has a wavelength of approximately 1565 nm, and the transmission spectrum has changed by approximately 1.8 dB beyond the allowable range.

Therefore, in the control of the optical signal processing device according to the present embodiment, first, the period between the current phase modulation amount and the target phase modulation amount is divided into M, and M+1 phase modulation amounts including the current phase modulation amount and the target phase modulation amount are calculated.
Current phase modulation amounts: φ01, φ02, φ03, φ04, φ05
First phase modulation amounts after division: φ11, φ12, φ13, φ14, φ15
Second phase modulation amounts after division: φ21, φ22, φ23, φ24, φ25
. . .
M−1-th phase modulation amount after division: φ(M−1)1, φ(M−1)2, φ(M−1)3, φ(M−1)4, and φ(M−1)5
Target phase modulation amounts: φM1, φM2, φM3, φM4, φM5

Thereafter, when changing the waveform, the phase modulation amount to be applied by each of the phase shifters 115-1 to 115-5 is changed from the k-th phase modulation amount to the (k+1)-th phase modulation amount among the M+1 phase modulation amounts, and this is performed by the phase shifters 115-1 to 115-5 one by one. By repeating this step M times from k=1 to k=M, the phase modulation amount applied by phase shifters 115-1 to 115-5 is gradually changed from the current phase modulation amount, and finally reaches the target phase modulation amount. The flow of the phase modulation amount changing process is as follows.
Step 1: φ01→φ11, φ02→φ12, φ03→φ13, φ04→φ14, φ05→φ15
Step 2: φ11→φ21, φ12→φ22, φ13→φ23, φ14→φ24, φ15→φ25
Step 3: φ21→φ31, φ22→φ32, φ23→φ33, φ24→φ34, φ25→φ35
. . .
Step M−1: φ(M−2)1→φ(M−1)1, φ(M−2)2→φ(M−1)2, φ(M−2)3→φ(M−1)3, φ(M−2)4→φ(M−1)4, φ(M−2)5→φ(M−1)5
Step M: φ(M−1)1→φM1, φ(M−1)2→φM2, φ(M−1)3→φM3, φ(M−1)4→φM4, φ(M−1)5→φM5

As described above, by changing the setting of the phase modulation amount to be added by the phase shifters 115-1 to 115-5 to the minute modulation amount divided as described later as division processing, even in a case where the waveform continuously changes, changes in the transmission spectrum of the lattice type optical circuit can be made within the permissible range even if the waveform is being changed, as shown in waveform C illustrated in FIG. 2.

As described above, according to the control of the optical signal processing device according to the present embodiment, the characteristic change of the optical signal processing device can be kept within the allowable range irrespective of the change of the phase shifter settings, and desired signal processing characteristics can be realized without affecting transmission characteristics in an optical communication network. Here, the transmission characteristic is a characteristic representing the transmission quality of an optical signal, such as a bit error rate.

In the present embodiment, the case where the phase shifters 115-1 to 115-5 perform one by one is shown in each step, but the phase shifters 115-1 to 115-5 may perform simultaneously when this is in the same step, or a plurality of the steps may be performed. The same applies to the case where N is another natural number. The setting of the phase modulation amount may be executed by software inside or outside the optical signal processing device or by hardware.

### (Division Processing)

In the control of the optical signal processing device according to the present embodiment, as a dividing method for dividing a period between the current phase modulation amount and the target phase modulation amount into M, the current phase modulation amount and the target phase modulation amount may be divided linearly or according to a lookup table of the phase modulation amount prepared in advance. The division number M is determined according to a difference between the current phase modulation amount and the target phase modulation amount and an allowable value of a change in optical characteristics passing through the optical signal processing device. If Q is an allowable value of a change in optical characteristics passing through the optical signal processing device, the optical characteristics at an arbitrary phase modulation amount setting φmn (m, n are integers, 1≤m≤M, 1≤n≤N−1) between the initial waveform and the target waveform are theoretically calculated in advance. The division number M is determined so that the optical characteristics are within a range ±Q between the initial characteristics and the target characteristics.

FIG. 3 is a flowchart illustrating processing of determining the division number of the phase modulation amount according to the first embodiment of the present invention.

First, the current phase modulation amounts φ01, φ02, . . . , φ05) and target phase modulation amounts (φM1, φM2, . . . , φM5) are acquired (S301). In addition, the division number M is set by the division number initial value (1 in this example) (S302).

Next, each phase modulation amount φmn3) is obtained by linear interpolation expressed by an expression φmn=φ0n+mΔφ (S303), and theoretical calculation of a wavelength spectrum for each phase modulation amount φmn is performed (S304).

Then, whether the calculated wavelength spectrum is within an allowable range is determined (S305). Here, the division number is not within the allowable range, the value of the division number is incremented (in this example, +1) (S307), and the processing of steps S303 and S304 is repeated. When it is determined that the calculated wavelength spectrum is within the allowable range, the division number M at that time is set as the division number to be obtained (S306), and this processing is finished. Although the division number initial value has been set to 1, other values may be used, or the value to be incremented may be an integer of 2 or more.

The transmission spectrum of the step S304 of the division processing can be performed as follows, for example. For example, a case where the optical waveguide constituting the optical signal processing device is a lattice type optical circuit and the transmission spectrum of the lattice type optical circuit can be linearly approximated to the wavelength is considered. The transmission spectrum of the lattice type optical circuit can be theoretically calculated by calculating an electric field after transmission for each path existing by the combination of arm waveguides passing in each stage and adding the electric fields for all the paths. According to this theoretical calculation, after division is performed into M in a period between the current phase modulation amount and the target phase modulation amount, all the transmission spectra that the lattice filter type optical circuit can take can be calculated in the above-mentioned steps. By performing theoretical calculation on the plurality of division numbers M, the division number M for suppressing the change of the transmission spectrum of the lattice type optical circuit to an allowable range can be obtained.

In the above example, the determination of each phase modulation amount is performed by linear interpolation, but a lookup table prepared in advance may be used.

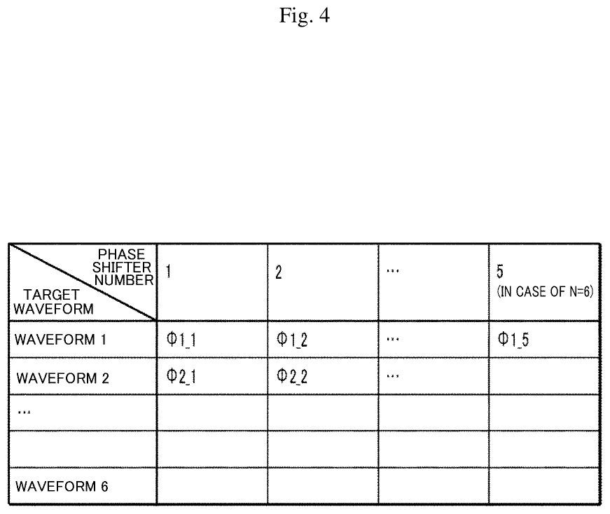

FIG. 4 is a diagram illustrating an example of the lookup table. Similarly to the above example, in an example of changing the waveform A (before change) to the waveform D (after change) in FIG. 2, four waveforms of the waveform (waveform C) in the middle of change are assumed, and in the lookup table, the phase modulation amounts φ1_1, φ1_2, . . . φ1_5, φ2_1, φ2_2, . . . of each phase shifter corresponding to the waveform A (=waveform 1), the waveform in the middle of change (=waveforms 2 to 5), and the waveform D (=waveform 6) are recorded as the contents of the table.

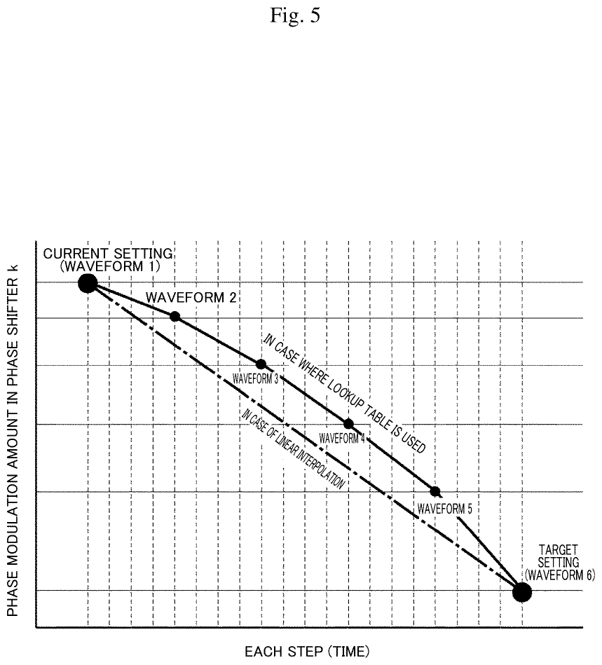

FIG. 5 is a diagram illustrating the phase modulation amount φn_k by the phase shifter k determined by using the lookup table illustrated in FIG. 4 in comparison with an example using linear interpolation. When each phase modulation amount is divided and determined from the present waveform to the target waveform, the phase modulation amounts corresponding to waveforms 2, 3, 4, and 5 are determined so that the steps (change times) of change from waveform 1 to waveform 6 are at equal intervals. When the waveform is further divided from the waveform, linear interpolation or the like may be used.

FIG. 6 is a flow chart illustrating processing of determining the division number M in the case of using the lookup table. The point different from the division processing illustrated in FIG. 3 is the determination processing of the phase modulation amount in step S603. That is, in this example, a lookup table illustrated in FIG. 5 is created for M determined in step S607, and then each phase modulation amount is determined by referring to the lookup table created in step S603.

Although the lookup table shows the case of six records from waveform 1 (=before change) to waveform 6 (=after change), the number of records is not limited to six. Further, it is not necessary that the waveform before the change is the leading record and that the waveform after the change is the final record.

Next, control of an optical signal processing device according to a second embodiment of the present invention will be described. In the second embodiment, the phase modulation amount to be applied by each phase shifter is determined to quantize and change the continuous change of the optical characteristics of the optical signal processing device (to change the optical characteristics into a minute (divided into M) state). Then, the phase modulation amount applied by each phase shifter is also changed by quantizing the continuous change within a certain phase range in accordance with the continuous change of the optical characteristics of the optical signal processing device.

As an example, a case where the optical signal processing device is a lattice type optical circuit as illustrated in FIG. 1, and its transmission spectrum is controlled to be linearly approximated to the wavelength is considered. That is, a case where the optical signal processing device is controlled as a tilt equalizer, that is, a case where each phase shifter of an optical signal processing device is controlled so that the wavelength spectrum of transmittance of the optical signal processing device has a linear shape with respect to wavelength is considered. In this case, in the second embodiment, the optical signal processing device is controlled so that the inclination (dB/nm) of the transmission spectrum of the tilt equalizer continuously changes. At this time, the phase modulation amount applied by each phase shifter is also continuously changed within the range of, for example, −7π to +7π in accordance with the continuous change of the spectral inclination of the tilt equalizer.

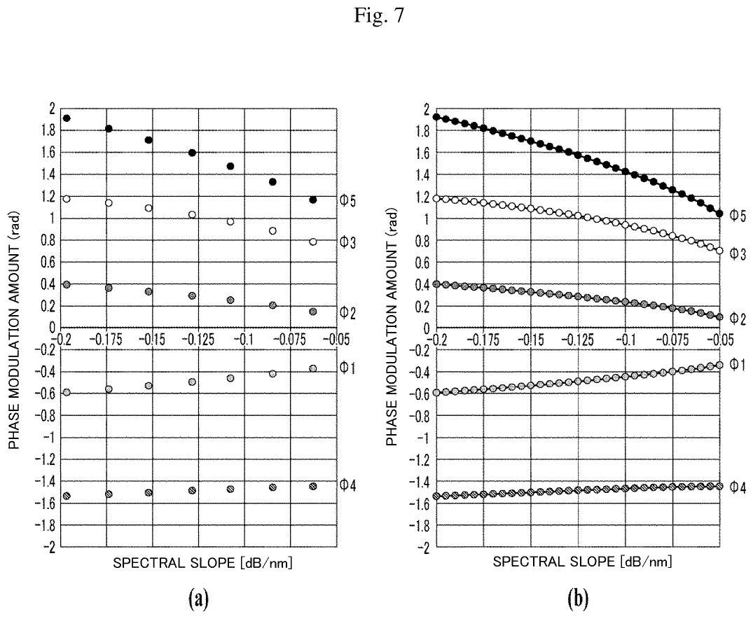

FIG. 7(a) is a diagram illustrating the phase modulation amount applied by each phase shifter for each spectrum slope (waveform shape).

As illustrated in FIG. 7(a), the phase modulation amount can be approximated by a continuous function with respect to the slope of the spectrum. This function can be obtained by theoretical calculation of the transmission spectrum of the lattice type optical circuit or by actually evaluating the transmission spectrum of the lattice type optical circuit.

Also in the present embodiment, in the control for changing the optical characteristics of the optical signal processing device from the present setting to the target setting, as in the first embodiment, the period between the current phase modulation amount and the target phase modulation amount is divided into M, and M+1 phase modulation amounts including the current phase modulation amount and the target modulation amount are calculated. The phase modulation amount to be applied to each of the phase shifters 115-1 to 115-5 is changed from the k-th phase modulation amount to the (k+1)-th phase modulation amount among M+1 phase modulation amounts one by one to the phase shifters 115-1 to 115-5. By repeating this step M times from k=1 to k=M, the phase modulation amounts to be applied in the phase shifters 115-1 to 115-5 are gradually changed from the present setting, and finally the target setting is reached. As division processing for dividing the period between the current phase modulation amount and the target phase modulation amount into M, in the relation of the phase modulation amount for each of optical characteristics illustrated in FIG. 7(a), a section between a plot of the current phase modulation amount and a plot of the target phase modulation amount is divided into M, the phase modulation amount is divided along the graph line. The determination processing of the division numbers M is the same as in the first embodiment.

FIG. 7(b) is a diagram illustrating the phase modulation amount added by each phase shifter for each slope of the spectrum after the phase modulation amount is divided. When the correspondence relation after division shown in FIG. 7(b) is obtained, the plots adjacent to each other in FIG. 7(a) may be connected linearly or smoothly by a curve.

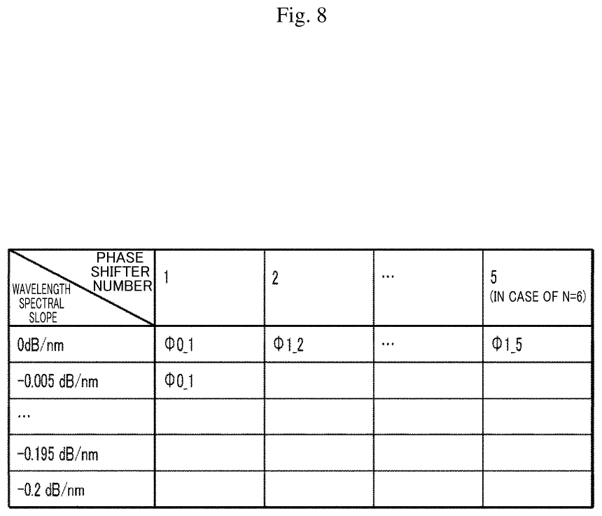

For example, a case where the optical waveguide constituting the optical signal processing device is a lattice type optical circuit and the lattice type optical circuit operates as a tilt equalizer is considered. It is assumed that the allowable value change in the transmission spectrum of the optical signal processing device is 0.3 dB. The slope of the current transmission spectrum is −0.2 dB/nm, and the slope of the target transmission spectrum is −0.1 dB/nm. At this time, in the graph of the phase modulation amount for each spectral slope illustrated in FIG. 7, on the graph line between the plot of the phase modulation amount −0.2 dB/nm and the plot of the phase modulation amount −0.1 dB/nm, the phase modulation amount is divided (=20 divisions) by spectral slopes of 0.005 dB/nm. At this time, as illustrated in FIG. 8, with reference to the lookup table that defines the amount of phase modulation for each spectral slope, it is determined in advance by theoretical calculation that the transmission spectrum that can be obtained when the above steps are performed once can be fit within the range of a straight line obtained by subtracting 0.3 dB from a waveform with a slope of −0.2 dB/nm and a straight line that adds 0.3 dB to a waveform with a slope of −0.1 dB/nm by dividing the amount of phase modulation from −0.2 dB/nm to −0.1 dB/nm by 20. That is, the initial waveform can be changed to the target waveform without adversely affecting the transmission characteristics.

### REFERENCE SIGNS LIST

10 Control unit
11 Lattice type optical circuit
111 Input waveguide
112 Output waveguide
113-1 to 113-N Optical directional coupler
114-1 to 114-(N−1) Arm waveguide
115-1 to 115-(N−1), 116-1 to 116-(N−1) Phase shifter

1. An optical signal processing device comprising:
an optical waveguide formed on a substrate; and
N phase shifters that apply a phase shift to an optical signal propagating in the optical waveguide, wherein the device is configured to perform:
a first step of dividing a period between a phase shift amount currently added and a target phase shift amount by a division number M, and acquiring (M+1) phase shift amounts including phase shift amounts before and after the change for each of the N phase shifters; and
a second step of changing a phase shift amount to be applied to each of the N phase shifters from a k-th phase shift amount to a (k+1)-th phase shift amount among the (M+1) phase shift amounts, from a first phase shifter to an N-th phase shifter among the phase shifters, and
executes processing of repeating the second step M times from k=1 to k=M.

2. The optical signal processing device according to claim 1, wherein
the division number M is determined by a difference between optical characteristics of current settings and optical characteristics of target settings, and
the number M of steps is determined so that optical characteristics which can be taken when the second step is performed once falls within a range of Q between the optical characteristics of current settings and the optical characteristics of target settings when an allowable value Q of the change of the optical characteristics passing through the optical signal processing device is given.

3. The optical signal processing device according to claim 1, wherein a method for controlling the optical signal processing device quantizes and changes a continuous change in optical characteristics of the optical signal processing device.

4. The optical signal processing device according to claim 1, wherein
a method for controlling the optical signal processing device includes quantizing and changing a continuous change in optical characteristics of the optical signal processing device, and
the phase shift amount to be applied to each of the N phase shifters is changed by quantizing a continuous change in a certain phase range in accordance with the continuous change in optical characteristics of the optical signal processing device.

5. The optical signal processing device according to claim 1, wherein the optical signal processing device is a gain equalizer, and determines the phase shift amount so that a gain equalization spectrum of the gain equalizer has a shape linearly changing with respect to an optical signal wavelength.

6. The optical signal processing device according to claim 1, wherein
the optical signal processing device includes at least one input port and at least one output port,
the optical signal processing device includes three or more two-input and two-output optical multiplexing/splitting circuits,
three or more two-input and two-output optical multiplexing/splitting circuits among the two-input and two-output optical multiplexing/splitting circuits are connected by a connection optical waveguide including two optical waveguides sandwiched between the two-input and two-output optical multiplexing/splitting circuits, and
one or more of the two optical waveguides forming the connection optical waveguide has a driven element including a phase shifter for applying a phase shift to an input optical signal.

7. The optical signal processing device according to claim 1, wherein the phase shifter uses a thermo-optic effect and is formed by heating the optical waveguide.

8. A method for controlling an optical signal processing device including an optical waveguide formed on a substrate; and N phase shifters that apply a phase shift to an optical signal propagating in the optical waveguide, the method comprising:
a first step of dividing a period between a phase shift amount currently added and a target phase shift amount by a division number M, and acquiring (M+1) phase shift amounts including phase shift amounts before and after the change for each of the N phase shifters;
a second step of changing a phase shift amount to be applied to each of the N phase shifters from a k-th phase shift amount to a (k+1)-th phase shift amount among the (M+1) phase shift amounts, from a first phase shifter to an N-th phase shifter among the phase shifters; and
executing processing of repeating the second step M times from k=1 to k=M.
